(19) United States
(12) Patent Application Publication
(10) Pub. No.: US 2006/0136560 A1
(43) Pub. Date: Jun. 22, 2006

(54) Scalable message forwarding

(75) Inventor: Yue Jun Jiang, Danville, CA (US)

Correspondence Address: ARENT FOX PLLC, 1050 CONNECTICUT AVENUE, N.W., SUITE 400, WASHINGTON, DC, 20036, US

(73) Assignee: Roamware Inc.

(21) Appl. No.: 11/294,329

(22) Filed: Dec. 6, 2005

Related U.S. Application Data
(60) Provisional application No. 60/633,844, filed on Dec. 6, 2004.

(51) Int. Cl. G06F 15/16

(52) U.S. Cl. 709/206

(57) ABSTRACT

The present invention provides a message and system forwarding messages sent to a subscriber address in a forwarding service, wherein the forwarding is done to at least one forward-to address associated with the subscriber address. The present invention maintains a record of subscriber addresses and associated forward-to addresses in a forwarding-associations database and updates a location-information database to redirect messages to a forwarding service address, if the messages are addressed to the subscriber address. The redirected messages are sent to at least one forward-to address associated with the subscriber address using the forwarding-associations database.

### RELATED APPLICATION

This application claims priority from U.S. Provisional Patent Application Ser. No. 60/633,844 entitled “Scalable SMS Forwarding”, filed Dec. 6, 2004, the entirety of which is hereby incorporated by reference.

### FIELD OF THE INVENTION

The present invention relates to message forwarding in a telecommunications network. More specifically, the present invention relates to Short Message Service (SMS) forwarding in Global System for Mobile communication (GSM) networks.

### BACKGROUND OF THE INVENTION

The Global System for Mobile communication (GSM) specification provides conditional or unconditional call forwarding. However, the specification does not provide for conditional or unconditional message forwarding. Even though the GSM specification has evolved over a period, the latest GSM specification still does not provide such support.

In today's world, many people (hereinafter, subscribers) own multiple phone numbers and handsets. It is likely that when a handset runs out of battery, or if the subscriber leaves the handset at home, the subscriber will want to forward both calls and messages to another handset. In the case where the network operator operates both Code Division Multiple Access (CDMA) and GSM networks, inter-standard message forwarding is even more useful. Two classes of message forwarding solutions exist to address this need today, SMSC-based solutions and SS7-based solutions.

In SMSC-based solutions, each time a Short Message Service Center (SMSC) receives a new message, or before the SMSC delivers a new message, it checks whether it should send the message to a forwarding number or a forward-to number. The SMSC performs this check through either an external function or an internal function. If the message is to be sent to the forwarding number, the SMSC sends the message in a standard way. However, if the message is to be forwarded to the forward-to number, the external/internal function may return the forward-to number and the forwarding conditions. If the message forwarding is unconditional, the SMSC will deliver the message to the forward-to number. If the message forwarding is conditional, the SMSC will first deliver the message to the forwarding number, and failing to do that, it will send the message to the forward-to number. If required, the SMSC may also send the message to both the forwarding and the forward-to numbers.

SMSC-based solutions collect the message forwarding status and the associated forwarding conditions of the forward-to number in an SMS forwarding database during a previous registration process. The registration process may be, for example, through a Mobile Originating SMS (MO-SMS) application.

However, SMSC-based solutions are not scalable, since all incoming messages to SMSC go through the SMS forwarding database check irrespective of whether a recipient has registered for SMS forwarding or not. The SMSC typically performs various other checks for the delivery of every SMS, such as an access list check for a sending party, and a blacklist check for a receiving party. However, the extra SMS forwarding database check can still be taxing during peak times. Another drawback of SMSC based solutions is that they require changes or special capabilities of the existing SMSC function.

Further, SMSC based solutions can not forward messages from a non-home SMSC when the non-home SMSC is directly sending message to the subscriber via SS7. For delivery of SMSs within national networks, it is possible to have a national forwarding database accessed by every SMSC. However, this solution still cannot handle forwarding of messages from an international SMSC to subscribers in the home network when the message delivery is via SS7. It is possible to modify a national roaming SMSC and sometimes, an international inter-working SMSC, to send the message to the home SMSC first. However, this approach requires significant changes to the national or the international SMSC delivery infrastructure. Further, such an inter-working approach cannot handle all the international SMSCs unless it intercepts SS7 messages. Furthermore, such a change of message inter-working infrastructure will require special efforts to handle billing and acknowledgements correctly.

On the other hand, the SS7-based approach takes a different approach to SMS forwarding. When the SMSC queries the Home Location Register (HLR) of the forwarding number for the number's location address (VMSCNLR), the query is redirected (via a network routing change) through an SMS Forwarding (SMSF) function. The SMSF returns itself as the location address if it is determined (either via query to HLR or from a registration database) that the message has to be forwarded. If it is determined that the SMS does not have to be forwarded, the query is relayed to the HLR without any modification.

Since every SMSC query is intercepted by the SMSF function, this approach is suitable for inter-working (national or international) SMSC or small operator SMSC environment.

The SS7-based solution combined with the SMSC-based solution can support message forwarding from non-home or international SMSCs. The adaptation will simply always return the SMSF function as the VMSCNLR location to receive all the inter-working (national or international) SMS messages. Once the messages are received, the SMSF function can decide to forward the message or perform normal message delivery.

Both the SMSC based solutions and the SS7 based solutions can be fully integrated within an SMSC with functional changes. However, the neither solution is scalable, since both require the SMSF to check if the message is destined for a forwarding number for every Mobile Terminating (MT) message delivery. For a small volume of message traffic, this check may be acceptable. But for large volumes of message traffic, the check slows down the process of message delivery. Further, these solutions also introduce the possibility of a message being forwarded although message forwarding is not set.

Thus, there is a need for a solution that provides an SMSC independent approach with scalable output, supports inter-standard message forwarding and requires no modification on operator's existing network elements.

### BRIEF DESCRIPTION OF DRAWINGS

In the drawings, the same or similar reference numbers identify similar elements or acts.

FIG. 1 illustrates the system used for forwarding a message from a forwarding number to a forward-to number.

FIG. 2 illustrates a message forward registration and cancellation system for setting message forward to a forward-to user in accordance with an embodiment of the invention.

FIG. 3 illustrates the flowchart of the message forward registration and cancellation process in accordance with an embodiment of the invention.

FIG. 4 illustrates a message forward and re-delivery system in accordance with an embodiment of the invention.

FIG. 5 illustrates the flowchart of the message forward and re-delivery process in accordance with an embodiment of the invention.

FIG. 6 illustrates a system for maintaining location changes of the forwarding handset in accordance with an embodiment of the invention.

FIG. 7 illustrates a flowchart for maintaining location changes of the forwarding handset in accordance with an embodiment of the invention.

FIG. 8 illustrates a system involved in the message redelivery process in accordance with an embodiment of the invention.

### DETAILED DESCRIPTION OF THE INVENTION

The present invention introduces a scalable and SMSC independent solution for message forwarding without requiring any modification on an existing network infrastructure. The present invention can be applied to forward messages from a national non-home SMSC as well as international SMSCs. In one embodiment of the invention, the message can be forwarded to an email address. In another embodiment of the invention, the message can be forwarded to a mobile number.

The present invention can be applied to forward messages to a forward-to number, in addition to call forwarding, when the forwarding handset is non-active, on a power-off mode, misplaced or when the battery has run-out. Although it is required that the call forwarding should be set before the message forwarding is set, it is not true vice-versa. However, as soon as the forwarding handset is “active” or “alive”, it will receive messages again.

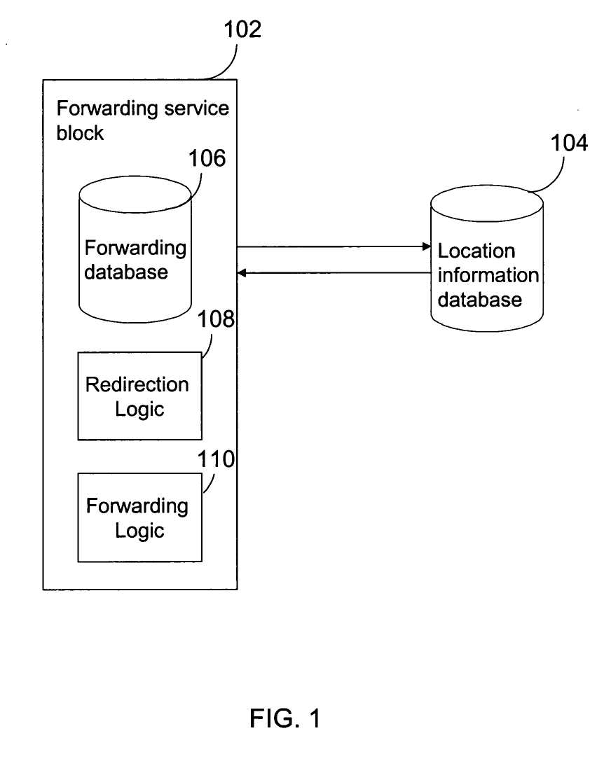

FIG. 1 illustrates the system used to forward a message from a forwarding number to a forward-to number. The system comprises of a forwarding service block 102 for sending messages to a subscriber address. Forwarding service block 102 contains a forwarding-associations database 106 that maintains a record of the subscriber address and associated forward-to addresses, a redirection logic 108 that updates a location-information database 104 to redirect messages to a forwarding service address, if the messages are addressed to the subscriber address and a forwarding logic 110 that sends the redirected messages to at least one forward-to address associated with the subscriber address using forwarding-associations database 106. In an embodiment of the present invention, forwarding service block 102 may be an independent block connected to location-information database 104. In another embodiment of the invention, forwarding service block 102 may be incorporated in location-information database 104.

The forwarding service block also includes a subscriber availability detection logic that updates the availability of the subscriber address to receive the messages. In an embodiment of the present invention, the subscriber availability detection logic comprises means for receiving a notification from the location-information database when the location-information database receives a location update from the subscriber address. In another embodiment of the present invention, the subscriber availability detection logic comprises a polling logic that checks the availability of the subscriber address. The polling logic further includes means for checking a mobile handset against a network monitoring data base which collects activity information for the mobile over a network interface (e.g. from Abis interface between base station and base station controller or A-interface between base station controller and switch). When a mobile is active, the mobile periodically sends network measurement results (such as signal strength, cell location information) over these interfaces.

In an embodiment of the invention, forwarding-associations database 106 may contain a record of a subscriber address and an associated forward-to address. In another embodiment of the present invention, forwarding-associations database 106 may contain a record of a subscriber address and its associated forward-to addresses. The forward-to address can be selected from a group consisting of a phone number (e.g. MSISDN), an International Mobile Subscriber Identity (IMSI), a mobile identity number (MIN), an equipment identifier (e.g. IMEI, ESN etc), an email address, a Blackberry address, a uniform resource identifier (URI), a SIP address and a Rich Site Summary (RSS) feed generator address.

Forwarding logic 110 comprises a means for extracting the subscriber address from the message. Once the subscriber address is extracted, a means for looking up at least one forward-to address associated with the extracted subscriber address is referred to determine at least one forward-to address. The message is forwarded by the means for forwarding the message to at least one looked up forward-to address.

Forwarding service block 102 optionally maintains a forwarding-log to record all messages forwarded through the forwarding service address. Whenever the subscriber is available to receive the messages, a report is sent to the subscriber address using a means for sending a report of forwarded messages to the subscriber address using the forwarding-log. The system further includes a billing logic to generate a call detail report for the subscriber address and at least one forward-to address.

In an embodiment of the present invention, the subscriber address may be a mobile phone number. In another embodiment of the present invention, the subscriber address may be an International Mobile Subscriber Identity (IMSI).

When a message is to be forwarded from a subscriber address in a forwarding service to at least one forward-to address, a record of subscriber addresses and associated forward-to addresses in a forwarding-associations database maintained in the forwarding service is looked into to determine the forward-to address. The forwarding service updates a location-information database with the forwarding service address to redirect the messages to the forwarding service address, if the messages are addressed to the subscriber address. The forwarding service then sends the redirected messages to at least one forward-to address associated with the subscriber address using the forwarding-associations database.

Once the forwarding service updates the location information database, forwarding message is set till the subscriber is available to receive messages. The redirected messages received by the forwarding service are directed to the forward-to number. To determine the forward-to number, the subscriber address is extracted from the message and at least one forward-to address associated with the extracted subscriber address is looked up in the location information database.

The forwarding service updates the availability of the subscriber address to receive messages, for example, either by way of a notification from the location-information database when the location-information database receives a location update from the subscriber address or by polling the subscriber address for checking availability.

When the subscriber address is available, the forwarding service suspends the redirected messages to be sent to at least one forward to address. The forwarding service can be configured to indefinitely suspend the redirected messages from being forwarded to a forward-to number. Alternatively, if the subscriber address requests the message forwarding to be continued, the forwarding service updates the location-information database to redirect messages to the forwarding service address.

The forwarding service maintains a forwarding-log to record all messages forwarded through the forwarding service address. A report of forwarded messages may be sent to the subscriber address using the forwarding-log once the subscriber address is available to receive messages.

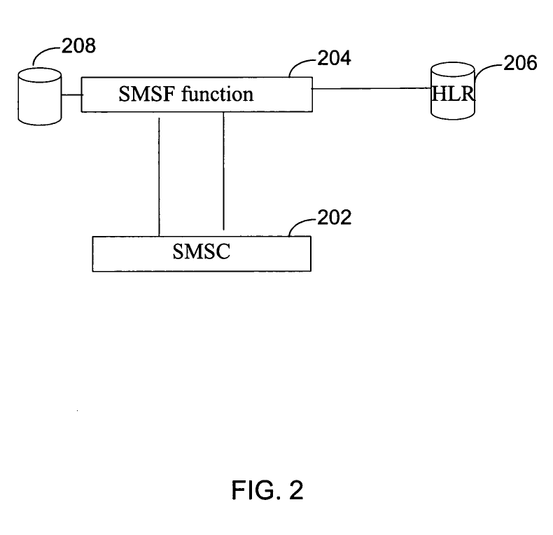

FIG. 2 illustrates a message forward registration and cancellation system for setting message forward to a forward-to number in accordance with an embodiment of the invention. The system includes an SMSC 202, an SMSF function 204 and an HLR 206. To initiate the message forward registration, SMSC 202 of the forwarding number sends a message forward registration request to SMSF function 204. The message forward registration request can be sent to the SMSF function, via for example, MO-SMS, Unstructured Supplementary Services Data (USSD), Wireless Application Protocol (WAP), the Internet, Interactive Voice Response (IVR), customer care, or a Subscriber Identity Module (SIM) Toolkit menu (STK). In one embodiment of the invention, the message forward registration request includes a phone number of a forward-to party. In another embodiment of the invention, the message forward registration request includes an email address of a forward-to party. In yet another embodiment of the invention, the message forward registration request may be empty. In this case, SMSF function 204 retrieves the forward-to party address from HLR 206, or from a forwarding relations database 208. Forwarding relations database 208 stores relations between the forwarding numbers and their associated forward-to numbers.

SMSF function 204 registers its address as the location address (VMSC /VLR) of the forwarding number in HLR 206 after receiving the message forward registration request from SMSC 202. Therefore, the message forward registration is set and the messages received thereafter by the forwarding number are directed to the forward-to number by SMSF function 204.

A message forward cancellation is initiated if any MO activity or new registration is performed by a handset of the forwarding number once the message forward registration is completed. A location update of the forwarding number is sent to HLR 206. HLR 206 is updated with a new location address (VMSC/VLR) of the forwarding number without the involvement of SMSF function 204. However, if a subscriber other than the forwarding number initiates message forward cancellation, SMSF function 204 issues a command, for example, MAP PurgeMS, to HLR 206. Then, HLR 206 does not update the location address of the forwarding user.

In an embodiment of the invention, a subscriber can set and unset call forwarding via a phone menu, and the aforesaid alternative method to set and unset message forwarding. In another embodiment, the subscriber can set and cancel both: call forwarding and message forwarding together.

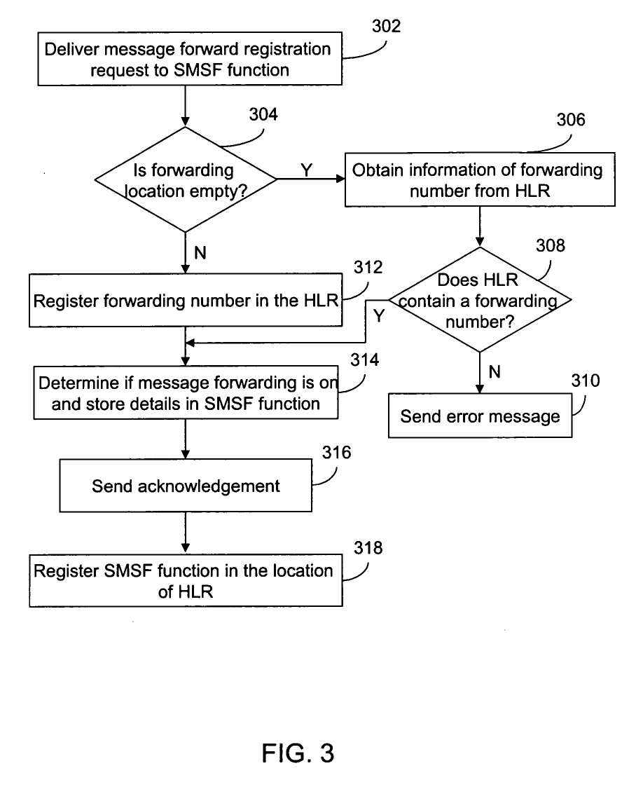

FIG. 3 illustrates the flowchart of the message forward registration and cancellation process in accordance with an embodiment of the invention. At step 302, a message forward registration request is sent to an SMSF function to initiate the message forward registration. By way of non-limiting examples, some of the alternatives for sending the message forward registration request to the SMSF function include MO-SMS, USSD or WAP or Web or IVR or customer care or SIM STK menu. In the foregoing description, as an example, the message forward registration request is send to the SMSF function as the MO-SMS.

The message forward registration request can contain a forward-to number or an empty value or an email address. The MO-SMS is delivered to the SMSF function with a destination address (e.g. SME address). A check is made at step 304 to determine if the forward-to number is present in the MO-SMS. If the forward-to number is not present, the SMSF function will seek the forward-to number from an HLR at step 306. In an embodiment of the invention, the forward-to number and identification of the forwarding party, e.g. IMSI, can be obtained from the HLR by issuing a MAP-SRI on the forwarding number MSISDN. In accordance with another embodiment, the forward-to number and identification of the forwarding party, e.g. IMSI, can be obtained from the HLR by issuing a MAP-SRI-SM on MSISDN and InterrogateSS on the IMSI returned from SRI-SM. At step 308, if no forwarding number is set at the HLR, an error message, for example, “no forwarding number is set”, is sent to the subscriber at step 310.

If the MO-SMS contains a forward-to number, the SMSF function registers the forwarding number in the HLR at step 312. In an embodiment of the invention, the SMSF function registers the forwarding number in the HLR by issuing MAP RegisterSS (CFU=Forward-to-number#) to the HLR of the forwarding number and possibly cancels any existing setting at the HLR. This allows the subscriber to use a single step message to register both call forwarding and message forwarding in accordance with an embodiment of the invention. However, in another embodiment of the invention, the subscriber can register only call forwarding with the help of the MO-SMS. In yet another embodiment of the invention, the subscriber can register only call forwarding, using a phone menu. In case only call forwarding is set, the forward-to number can be preceded with a prefix text, for example, “Call”.

If a network operator allows different call forwarding and message forwarding numbers for a subscriber, then the subscriber can chose one amongst the possible solutions. One of the solutions may allow the subscriber to use different SME addresses to indicate the different call forwarding and message forwarding numbers. Alternatively, the subscriber may use the same SME address but prefix the forwarding number with “SMS” or “Call”. For example, if the same SME number, the subscriber can send a MO-SMS to the SME address, with the following possible text

SC—same as call forwarding number (CFU)
SMS+19255551212—message forwarding number different from CFU

Call+19255553455—set unconditional call forwarding number
SC+19255551212—set both call forwarding and message forwarding to be same number
SMS johndoe@yahoo.com—message forwarding to an email address

The SMSF function stores the forwarding number in forwarding-associations database and sets message forwarding status on for the forwarding number at step 314. The SMSF function will also store forward-to number and the identification, for example, IMSI, of the forwarding number. An acknowledgement message, for example, “OK”, is sent to the forwarding number to inform that the message forwarding status is set at step 316. Once the message forwarding for the forwarding number is set, the SMSF function immediately registers its address as the location address (VMSC/VLR) of the forwarding number in the HLR of the forwarding number at step 318.

When the handset of the forwarding number cancels the message forwarding, there is no need for the SMSF function to make any changes in the HLR, because the HLR will have the real location of the forwarding number. However, if a party other than the forwarding handset cancels the message forwarding, the SMSF function will issue a location removal command, for example, MAP-PurgeMS to the HLR of the forwarding number.

In an embodiment of the invention, when the SMSF function is accessed for message forward registration and cancellation process, authentication may be required (e.g. with number if not the forwarding handset and pin).

The change of the SMSF function as the VMSC/VLR location of the forwarding handset at the HLR of the forwarding number has no impact on any valued added services. Examples of value added services include, but are not limited, to prepaid, roaming and GPRS services. This is because the message forwarding and the change of the HLR location of the forwarding number require that: (i) The user has requested call forwarding at the HLR for the forwarding number, and (ii) There is no MO-activity and new registration from the forwarding handset. This means that the HLR will forward all incoming calls unconditionally to the SMSF function. Further, whenever any MO-activities occur, the HLR will have the real VMSCNLR location and profile through which the mobile phone has joined the network.

Further, since the HPMN always receives the location query of the HLR, the change of the SMSF function as the VMSC/VLR of the forwarding handset will have no relationship with roaming. The subscriber of course can register SMS forwarding when roaming. In addition, when the roamer is initiating any MO-activity or new registration, the HLR will have the real location of the user.

Normally, an SMS is delivered via the VMSC location of a GSM attached handset. However if GPRS, and SMS over GPRS (normally via VMSC/VLR only) are also supported by the network, during SMS forwarding registration, SMSF function can additionally issue SRI-SM (forwarding-number, GPRS support indicator). If the SGSN is returned, it indicates that the forwarding handset is currently GPRS attached. In this case, the SMSF function can then issue GPRS UpdateLocation with the SMSF function (IP address and E164 number) as the SGSN IP address and E164 number at the HLR of forwarding number. In this way, when a SMS is delivered to a forwarding subscriber via GPRS is attempted, it will also sent to the forwarding service so the forwarding service can redirect the message to the forward-to address.

Alternatively, the operator can choose to ignore this case so to allow SMS delivery via GPRS if the handset is still GPRS attached. That is, if the forwarding handset is still GPRS attached (even though it is not GSM-attached), then a SMS sent to the forwarding handset via GPRS can still reach the GPRS attached forwarding handset. As a result, SMS over GPRS is not really forwarded when the handset is GPRS attached.

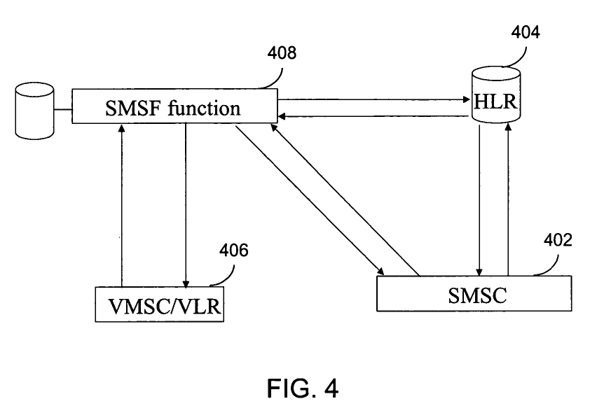

FIG. 4 illustrates a message forward and re-delivery system in accordance with an embodiment of the invention. The message forward and re-delivery system includes an SMSC 402, an HLR 404, an SMSF function 408 and a VMSC/VLR 408. When SMSC 402 initiates delivering a message to a forwarding number, it inquires from HLR 404 of the forwarding number a location address and identity of the forwarding number. In an embodiment of the invention, a MAP SRI-SM of the forwarding number can be issued to HLR 404 to determine the location address (VMSCNLR) of the forwarding number while identity of the forwarding number can be obtained from the IMSI. If the forwarding number has not registered for message forward, the location in HLR 404 will not point to SMSF function 408 and a standard message delivery mechanism would be applied.

However, if the forwarding number has registered for message forwarding, HLR 404 will return the location address of the SMSF function 408 to SMSC 402 as the location where the message is to be forwarded. The message to be delivered to the forwarding number will be sent to SMSF function 408, which, in turn, will look up the forwarding-associations database to find the forward-to number.

SMSF function 408 generates its own message reference for its message delivery, and correlates that with the originating SMSC address and the original message parameters. SMSF function 408 simply relays the message to VMSCNLR 406 of the forward-to number and, generally, does not store any message, although it can do so for logging and CDR purposes. However, it changes the SMSC parameter in the relay, so that the acknowledgement and subsequent acknowledgements due to further handset activities can be relayed via SMSF function 408 to the originating SMSC. The further handset activities include, but are not restricted to, message read and user menu response. Further, SMSF function 408 may also handle types of the messages (e.g. delivery receipt, read acknowledgement, user menu response, intermediate notification etc). It may also handle message mode (e.g. datagram mode, store & forward mode and transaction mode) of the originating SMSC via relay through SMSF function 408.

If the message delivery is successful, the acknowledgement from VMSCNLR 406 of the forward-to number will be relayed via SMSF function 408 to the originating SMSC, which can subsequently acknowledge to a sending party who requested delivery receipt. Subsequent acknowledgements by the forward-to number can also be relayed through SMSF function 408 or can be directly sent to the originating SMSC based on implementation configurations.

If the message delivery to the forward-to number fails, SMSF function 408 will relay the failure reasons back to the originating SMSC. In addition, if the failure reasons are due to forward-to handset power off or message memory capacity exceeded, then SMSF function 408 can optionally store the message and send delivery report to the HLR of the forward-to number to be alerted for future delivery.

However, if the forwarding handset is alive again with a new location update (e.g. powered back on), it will be able to receive those messages that were not delivered to forward-to handset.

In accordance with an embodiment of the invention, when the SMSC sends the message to the SMSF function, the SMSF function can resubmit the new message back to the SMSC via an IP protocol such as SMPP or UCP. For example, if party A sends a message to party B, and party B forwards the message to party C, the SMSF function will submit to the SMSC a new message as if it is from A to C. The SMSF function would issue a message delivery report to party A directly. For the transmission of the message delivery report directly, the SMSC should support immediate delivery of message. Otherwise, the SMSF function will have to acknowledge to the SMSC of the successful delivery of A's message to B when the SMSC sends the message to the SMSF function. The SMSF function will then have to resubmit to the SMSC for message from A to C which will cause another acknowledgement.

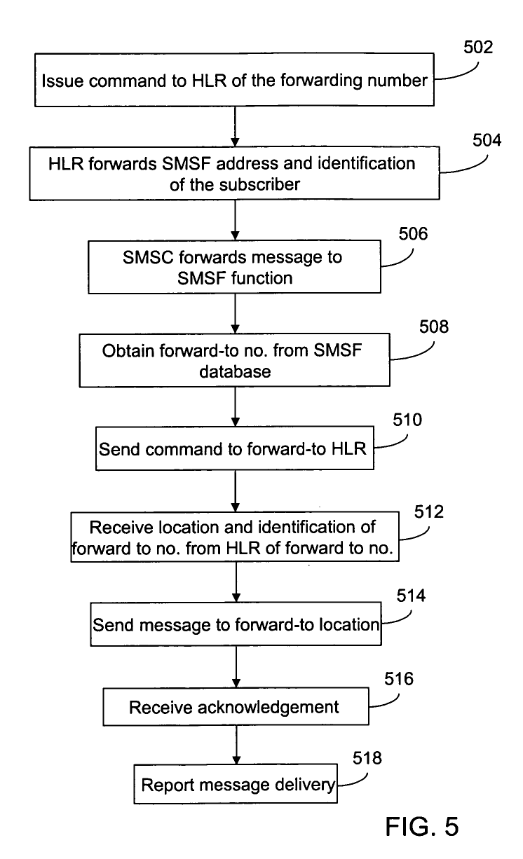

FIG. 5 illustrates the flowchart of the message forward and re-delivery process in accordance with an embodiment of the invention. At step 502, an SMSC issues a command to an HLR of a forwarding number, to find the location address and identification details of the forwarding number for delivering a message to the forwarding number. In an embodiment of the invention, the command issued by the SMSC may be MAP SRI-SM and the identification details may include the location address (for example, VMSCNLR) and IMSI of the subscriber. The HLR of the forwarding number returns the location address of the SMSF function to the SMSC as the location address of the forwarding number if the subscriber has set message-forward to a forward-to number at step 504. However, if the subscriber has not set message-forward, the location address will not point to the SMSF function and a standard message delivery mechanism will be applied.

At step 506, the SMSC sends the message to the SMSF function. The SMSF function determines the forward-to number using a forwarding-associations database at step 508, and sends a command to the HLR on forward-to number, to find the location address of the forward-to number at step 510. In an embodiment of the present invention, the command is MAP SRI-SM. The HLR of the forward-to number returns the location address and identification details of the forward-to number to the SMSF function at step 512. The SMSF function sends the message to the forward-to number via another command, for example, MAP Forward MT SMS to a VMSCNLR of the forward-to number at step 514. The SMSF function receives successful/unsuccessful delivery acknowledgement from the VMSCNLR of the forward-to number at step 516 and reports the same to the HLR of the forward-to number at step 518.

If the message delivery is successful, the acknowledgement of successful message delivery is relayed from the VMSCNLR of the forward-to number via the SMSF function to the originating SMSC. The SMSC may then send an acknowledgement to a sending party who had requested delivery receipt. If the originating SMSC allows, various other acknowledgements can be sent for other activities, for example, read acknowledge and user menu response.

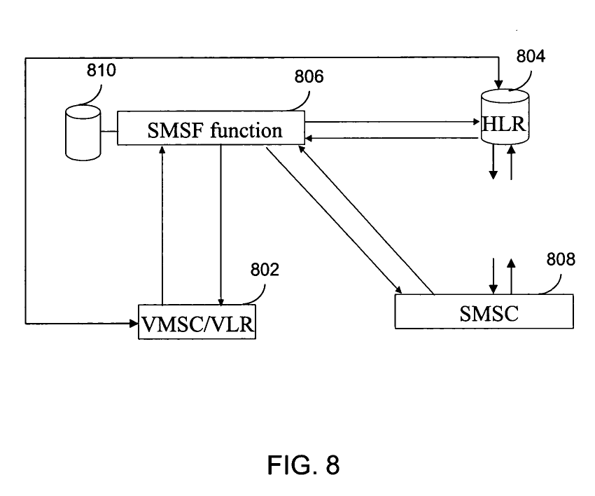

If the message delivery to the forward-to number is unsuccessful, the SMSF function will relay the reasons for failure to the originating SMSC. In addition, if the failure reasons are due to forward-to handset power-off or SMS memory capacity exceeded, then the SMSF function may optionally store the message and send delivery report of the forward-to number to the HLR that may be alerted for message redelivery as depicted in FIG. 8.

In an embodiment of the invention, the forwarding handset may receive the messages that were not delivered to the forward-to handset once the forwarding handset is alive again (e.g. powered back on). In another embodiment of the invention, the forwarding handset may receive all the messages that were forwarded to a forward-to handset once the forwarding handset is alive.

In various embodiments, the network elements used in conventional GSM networks, for example, SMSC inter-working, network routing, internal SMSC functions and HLRs that are used in the system, do not require any modification. However, if the HLR has access control on SMSC or VMSCNLR, the addition of a SS7 SMSF functioning like a VMSCNLR and SMSC might require HLR configuration change, which depends on how HLR checks the E164 numbers associated with the SMSF. For example, if the HLR checks based only on the CC NDC prefix, then there is no need for configuration change at HLR. However, if the HLR checks the whole E164 numbers for SMSC access control or VMSCNLR registration, then a configuration change will be needed at all national HLRs.

In an embodiment of the present invention pertaining to message forwarding to an international number, in addition to SS7 method, the SMSF function can also forward the message via a TCP/IP protocol (e.g. SMPP) to an SMSC or an SMS inter-working gateway that already has the inter-working relationships with all the inter-working operators. The inter-working gateway (e.g. via SMPP) may also be required between operators of the same country in addition to the SS7 method.

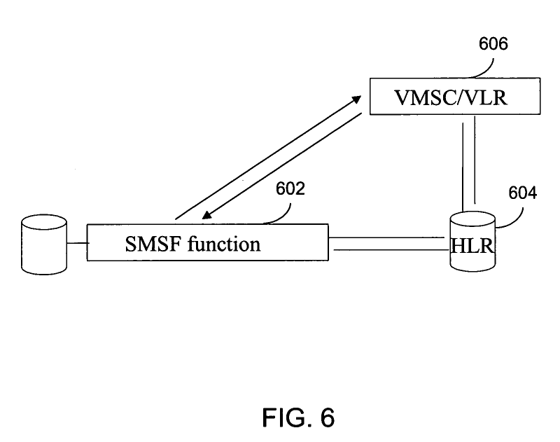

FIG. 6 illustrates a system for maintaining location changes of the forwarding handset in accordance with an embodiment of the invention. The system includes an SMSF function 602, an HLR 604, and a VMSCNLR 606. When a forwarding handset initiates a MO activity or changes a location (e.g. power on or periodical location update or just new location area/VMSCNLR etc), HLR 604 of the forwarding number receives a new location update (VMSCNLR 606). The location update is received because either VMSCNLR 606 was cancelled by the SMSF function's registration at HLR 604 or VMSCNLR 606 is new. The location address of VMSCNLR 606 at HLR 604 of the forwarding number will be changed to the real location address (VMSCNLR 606). HLR 604 alerts SMSF function 602 the location address change made in HLR 604 (for example, via MAP cancel-location since the SMSF function was the VMSCNLR). Based on the configuration condition, SMSF function 602 may optionally send a message to the forwarding handset to alert the subscriber if the message forwarding is requested. This allows the forwarding handset to cancel the message forwarding via a MO-activity, for example, via message or USSD or WAP or Customer care or IVR.

It is also essential for the subscriber to cancel call forwarding, as it does not make sense for the subscriber to cancel call forwarding while the subscriber keeps message forwarding. When an MO activity is initiated, or a location change of the forwarding handset is initiated, the message forwarding will be canceled unless certain conditions are satisfied. The conditions are configurable and implementation dependent.

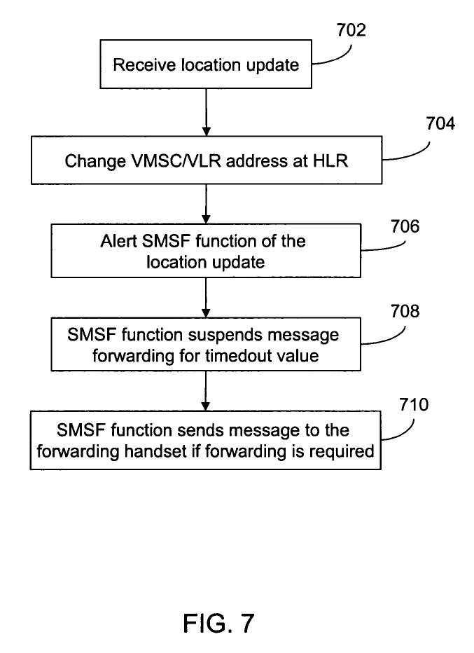

FIG. 7 illustrates the flowchart for maintaining location changes of the forwarding handset in accordance with yet another embodiment of the present invention. The HLR of the forwarding number at step 702 receives a location update when the forwarding handset initiates a MO activity or changes a location. The location update is received because either the VMSCNLR was cancelled by the SMSF function's registration at the HLR or the VMSCNLR is new. Examples of change of location include, without limitations, power on again, periodical location update or a new location area/VMSCNLR. The VMSCNLR address at the HLR of the forwarding number will change to the real location address from the SMSF function address set by the SMSF function at step 704. The SMSF function is alerted of the VMSCNLR change made in the HLR of the forwarding number at step 706. In an embodiment of the present invention, MAP CancelLocation from HLR alerts the SMSF function of the VMSCNLR change.

As the handset will be unable to send a message to cancel message forwarding, or do other MO activities such as making a call or changing forwarding number, the location update will not be reissued immediately other than when the handset is off. To address this concern, the SMSF function temporarily suspends message forwarding on the forwarding number with a configurable timeout value at step 708 after receiving a CancelLocation event from the HLR. It will next send a confirmation message to the forwarding handset to alert the subscriber and confirm if the subscriber wants to continue message forwarding at step 710. If the subscriber replies to the confirmation message within the configurable timeout value, the SMSF function will again issue a LocationUpdate to the HLR of the forwarding number to register its location address. The subscriber may also use MO-SMS to reset the message forwarding. If the message forwarding is not refreshed after a time out value, the message forwarding for the forwarding number may be removed.

The subscriber rarely wishes to continue to forward messages to another number when a handset is on even if the subscriber has registered to call forwarding. Therefore, it is inconvenient to the subscriber when it receives a confirmation message each time the handset initiates a MO-activity or location update (e.g. powered on again). In accordance with the first embodiment, a configurable time out value is defined by the SMSF function. The time out value starts after the HLR of the forwarding number receives CancelLoc. If the time out value expires and the message forwarding is not canceled by the forwarding subscriber, the SMSF function automatically sets the location address of the SMSF function as of the location address of the forwarding subscriber at the HLR. There is no need to send the confirmation message to the subscriber.

In another embodiment of the present invention, the SMSF function changes the location at the HLR back to SMSF function after receiving CancelLoc from the HLR of the forwarding subscriber. If the SMSF receives a CancelLoc again within a short configurable time, one of two events occur: either the confirmation message is sent, or the process is repeated in accordance with the first embodiment.

In yet another embodiment of the present invention, the status of the subscriber is polled at a configurable interval by issuing a command, (for example, MAP PSI, for networks that support it such as Camel capable networks) to the current VMSC/VLR of the forwarding subscriber. If the subscriber status is idle, the SMSF function immediately changes the location (VMSCNLR) of the HLR back to the SMSF function.

Although all the above embodiments have been described using GSM technology, the same can be implemented in GPRS technology.

FIG. 8 illustrates the system involved in a message redelivery process in accordance with an embodiment of the invention. SMSF function 806 stores the message in a forwarding-associations database 810 that was not successfully delivered to the forward-to number. In an embodiment of the present invention, forwarding-associations database 810 stores all the delivered or undelivered messages to the forward to number. A VMSCNLR 802 of the forward-to handset sends an availability message to an HLR 804 of the forward-to handset when the forward-to handset powers on again or when message memory capacity is available. HLR 804 of the forward-to handset notifies SMSF function 806 when the forward-to handset is available because SMSF functions as a SMSC when SMSF sent a delivery report to the HLR of the forward-to handset on the failure of SMS to the forward-to handset. This serves as the notification of the availability of the forward-to number. SMSF function 806, in turn, fakes (faking because the forward handset might not really be available) the availability of the forwarding handset to the HLR of the forwarding handset. When this happens, the forwarding handset is declared available to prompt the redelivery process of messages, irrespective of the real availability of the forwarding handset. HLR of the forwarding handset notifies the availability of the forwarding handset to a sender SMSC 808, which restarts the whole delivery process of the message to the forwarding handset.

In an embodiment of the invention, VMSCNLR 802 of the forward-to handset sends ReadyForSMS on the forward-to IMSI to HLR 804 of the forward-to handset when the forward-to handset powers on again or message memory capacity is available. HLR 804 of the forward-to handset acknowledges the ReadyForSMS command and in turn, sends a MAP AlertServiceCenter to SMSF function 806. SMSF function 806 acknowledges the MAP AlertServiceCenter and sends the MAP ReadyForSMS on forwarding IMSI to the HLR of the forwarding number, which then sends AlertServiceCenter to sender SMSC 808. In another embodiment of the invention, the SMSF function can directly send AlertServiceCenter to sender SMSC 808, if the message is recorded in forwarding-associations database 810. Sender SMSC 808 will again start the sequence of message delivery on the forwarding number.

In addition to message forwarding and message redelivery, in one embodiment of the present invention, the SMSF function can be configured to perform various other tasks. This is because the message of the forwarding handset is always routed through the SMSF function. The SMSF function can also perform logging, reporting and CDR generation. These activities can be used for bookkeeping purpose, statistical reporting (for example, reporting on how many people set SMS forwarding, how many messages they sent on average since set, and what is the message rate etc) and billing.

The forwarding party may be charged for the services based on the number, individual or bucket, of successfully forwarded messages in a message forwarding monthly subscription. Alternatively, the forwarding party may be charged either each time the SMS forwarding is set (e.g. including reset) or changed (e.g. can be only if the forward-to number is different from previous one).

In another embodiment of the present invention, the SMSF function can send a message to multiple forward-to numbers. The SMSF function can store the messages that were delivered to the forward-to handset (handsets). When the forwarding number is registered again, the SMSF function can deliver the messages to the forwarding handset.

In yet another embodiment of the present invention, the SMSF function may handle looping situation where A forwards to B, B forwards to C and C forwards to A. In particular, the SMSF function can cut the chain short and do direct message forwarding. For example, if A forwards to B, B forwards to C and C forwards to D, the SMSF function can directly send the message to D when A sends the message. The SMSF function, however, can still generate charging records for A, B and, C individually.

In yet another embodiment of the present invention, the SMSF function can perform SNMP and blacklist/whitelist functions. If a number is blacklisted, the SMSF function will not set message forwarding for that particular number. If a number is whitelisted, the SMSF function can be used to perform testing function. There may also be destination-forward blacklists. For example, if an operator does not want to forward its number to a competitor's number, it may do so by adding a prefix.

The aforesaid embodiments are exemplary and included to illustrate the spirit and scope of the present invention. However, they should not be construed in any way as limiting the present invention. It will be apparent to a person skilled in the art that several other variations can be made to the present invention and still fall within the scope of the present invention.

In various embodiments, the SMSF function supports both ANSI-41 interface and protocol stack, and GSM MAP interface and protocol stack. Table 1 lists the equivalent commands of GSM MAP in ANSI 41D.

TABLE 1

| GSM MAP | ANSI 41D |
|---|---|
| Location Update/ISD | REGNOT |
| Cancel Location | REGCAN |
| RegisterSS | FEATUREREQUEST |
| InterrogateSS | FEATUREREQUEST |
| SRI-SM | SMSREQ |
| SRI | LOCATION REQUEST |
| ForwardSMS | SMSDPP |
| ReadyForSMS | SMSNOTIFICATION |
| AlertServiceCenter | SMSNOTIFICATION |
| ReportSMSDelivery | SMDPP |

When a GSM operator introduces CDMA service, it is desirable to forward the GSM message and call of a GSM number to the new CDMA number. Conversely, CDMA message and call of a CDMA number can be forwarded to the new GSM number. Same is also equally applicable between GSM and TDMA. The present invention permits inter-network transmission of call and messages. This is further illustrated with the help of the following example.

Let X be the operator who has implemented message forwarding, and Y be the other operator. It is known that the location update, SS service and message can work at the X operator. For forwarding a message from an X number to a Y number, the present invention will forward the message to Y's number as long as message inter-working (via SS7 or IP) works between the two operators.

Since the proposed solution uses location update, message and supplementary service related MAP messages (GSM or ANSI-41D), the message forwarding approach will work for message forwarding from the Y number to the X number as long as these messages may be accepted from the Y's HLR.

An example is now presented to illustrate state management in accordance with the present invention. When A sends a message to B and B has set forwarding to C, it is possible that the SMSF function has obtained the state of delivery “A to C” (for example—successful, busy or unreachable). However, the SMSC function of A will consider the delivery of message from A to B as failure due to, for example, time out. This will not be a problem if the delivery is not successful since the SMSC function of A will retry delivering the message. If the delivery is successful, it will result in some duplicated messages to the C. To address this issue, in accordance with various embodiments of the present invention, SMSF function records the successful state of a forwarded delivery when it could not pass the state information to the SMSC of A. This way, when the originating SMSC of A tries again to deliver the SMS to B, the SMSF function treats the message as a successful delivery if it has already delivered the same message from A to C, by correlating the message reference of the two attempts.

When a message is forwarded from a forwarding number to a forward-to number, the forwarding subscriber is charged. When a party A sends a message to a party B and the party B has set forwarding to a party C, then after the SMSF function delivers the message from the party A to the party C, CDR will be generated. The SMSF function will generate the CDR containing fields of the parties A, B and C and message delivery success/failure. The CDR will also contain the originating SMSC address of the party A and the SMSF function address, if involved, to forward the message to the party C. The operator will use the CDR to bill the B-party. The exact format of the CDR depends on the operator requirements. The CDR format may include originating SMSC address, Sending Party address, Forwarding-party address, Forward-to-party address, Destination MSC address, SMSF function address, Time and Date, Size of the message, Status of forwarding delivery, Status of sending delivery, and the like.

To bill the forwarding party, a billing system of a deploying operator of the message forwarding may be changed in the following aspects

1. The CDR from the SMSF function may be used to bill the forwarding party.

2. A message gateway between different networks of the same or different operators may have the interface to include the forwarding party and to generate the CDR including the forwarding party.

3. The operator's billing system may process the message gateway CDR to bill the forwarding party instead of the sending party, to avoid double-billing of the sending party. The billing system of a deploying operator of the message forwarding might change for some other considerations also.

Various embodiments are included in the description to illustrate the billing system. However these embodiments are exemplary and do not limit the scope of the invention.

In accordance with one embodiment of the billing system, the billing system of an operator, for example, China Unicom, uses GSM network. Here, a China Unicom GSM subscriber A sends a message to a China Unicom GSM subscriber B who has set forwarding to a China Unicom GSM subscriber C. Unicom SMSC of the A-party generates CDR and billing to the A-party for sending a message to the B-party. The CDR may contain sending party identification and receiving party identification.

The SMSF function will generate the CDR of the forwarding message. The CDR of the forwarding message may contain sending party identification, forwarding party identification and receiving party identification. The Unicom billing system uses the SMSF CDR to bill the B-party (since there is no destination message gateway involved).

In accordance with a second embodiment of the billing system, the billing system of an operator, for example, China Unicom, uses CDMA network. Here, a China Unicom CDMA subscriber A sends a message to a China Unicom CDMA subscriber B who has set forwarding to a China Unicom CDMA subscriber C. A Unicom SMSC of the A-party generates CDR and billing to the A-party for sending a message to the B-party. The CDR may contain sending party identification and receiving party identification.

The SMSF function will generate the CDR of the forwarding message. The CDR generated by the SMSF function may contain sending party identification, forwarding party identification and receiving party identification. The Unicom billing system uses the SMSF CDR to bill the B-party (since there is no destination message gateway involved).

In accordance with a third embodiment of the billing system, the billing system of an operator, for example, China Unicom, uses CDMA and GSM networks. Here, a China Unicom GSM subscriber A sends a message to a China Unicom CDMA subscriber B who has set forwarding to a China Unicom CDMA subscriber C. A Unicom message gateway between GSM and CDMA networks generates the CDR and billing of the A-party. The CDR generated by the Unicom message gateway may contain sending party identification and receiving party identification. The CDR of the originating SMSC of the A-party will not be billed by recognizing the receiving number as CDMA number and the sending number as GSM number.

The Unicom message gateway will deliver the message “A to B”. The message is then sent to the SMSF function for forwarding the message to the C-party. The SMSF function generates the CDR of the forwarding delivery. The CDR generated by the SMSF function may contain sending party identification, forwarding party identification and receiving party identification. The Unicom billing system uses the SMSF CDR to bill the B-party (since there is no destination message gateway involved).

In accordance with a fourth embodiment of the billing system, the billing system of an operator, for example, China Unicom, uses CDMA and GSM networks. Here, a China Unicom CDMA subscriber A sends a message to a China Unicom GSM subscriber B who has set forwarding to a China Unicom GSM subscriber C.

A Unicom message gateway between the CDMA and the GSM networks generates the CDR and billing of the A-party. The CDR generated by the Unicom message gateway may contain sending party identification and receiving party identification. The CDR of the originating SMSC of the A-party will not be billed by recognizing the receiving number to be a GSM number and the sending number to be a CDMA number. The Unicom message gateway delivers the message of the A-party to the B-party which is then sent to the SMSF function for forwarding the message to the C-party. The SMSF function generates the CDR of the forwarding delivery. The CDR generated by the SMSF function may contain sending party identification, forwarding party identification and receiving party identification. The Unicom billing system uses the SMSF CDR to bill the B-party (since there is no destination message gateway involved).

In accordance with a fifth embodiment of the billing system, the billing system of an operator, for example, China Unicom, uses CDMA and GSM networks. Here, a China Unicom GSM subscriber A sends a message to a China Unicom CDMA subscriber B who has set forwarding to a China Unicom GSM subscriber C.

A Unicom message gateway between the GSM and the CDMA networks generates the CDR and billing of the A-party for the message “A to B”. The CDR generated by the Unicom message gateway may contain sending party identification and receiving party identification. The CDR of the originating SMSC of the A-party will not be billed by recognizing the receiving number as a CDMA number and the sending number as a GSM number. The Unicom message gateway will deliver the message of the A-party to the B-party which will be sent to a SMSF function for forwarding the message to the C-party. The SMSF function will interface the Unicom message gateway between the CDMA and the GSM networks which will be responsible for generating the billing and CDR of the message “A to C”. To avoid double billing of the A-party, the SMSF function sends B-party information to the Unicom message gateway as well. The Unicom message gateway generates the CDR to record the forwarding party B after processing the B-party information.

The Unicom billing system recognizes the presence of the forwarding party from the Unicom message gateway CDR and bills the B-party (the forwarding party) instead of the A-party. The SMSF function generates the CDR of the forwarding message for the party B. However, the CDR of the forwarding message is not sent to the Unicom billing system based on the recognition of the destination Unicom message gateway since the Unicom message gateway only contains successful delivery status.

In accordance with a sixth embodiment of the billing system, the billing system of an operator, for example, China Unicom, uses CDMA and GSM networks. Here, a China Unicom GSM subscriber A sends a message to a China Unicom GSM subscriber B who has set forwarding to a China Unicom CDMA subscriber C. The SMSC of the A-party generates the CDR and billing on the A-party for the message “A to B”. The CDR generated by the SMSC may contain sending party identification and receiving party identification.

A SMSF function attempts the delivery of the message “A to C” through the Unicom message gateway between the GSM and CDMA networks, which will be responsible for generating the billing and CDR of the message “A to C”. To avoid double billing of the A-party, the SMSF function sends the information regarding the B-party to the Unicom message gateway. The Unicom message gateway generates the CDR to record the forwarding party B after processing the B-party information.

The Unicom billing system would recognize the presence of the forwarding party from the Unicom message gateway CDR and bill the B-party (the forwarding party) instead of the A-party. The SMSF function generates the CDR of the forwarding message. But the CDR generated by the SMSF function is sent to the Unicom billing system based on the recognition of the destination message gateway, since the message gateway only has successful delivery status.

In accordance with a seventh embodiment of the billing system, the billing system of an operator, for example, China Unicom, uses CDMA and GSM networks. Here, a China Unicom CDMA subscriber A sends a message to a China Unicom GSM subscriber B who has set forwarding to a China Unicom CDMA subscriber C.

A Unicom message gateway between the CDMA and the GSM networks will generate the CDR and billing of the A-party for the message “A to B”. The CDR of the originating SMSC of A-party will not be billed by recognizing the receiving number as a GSM number and the sending number as a CDMA number. The Unicom message gateway will deliver the message of the A-party to the B-party, which will be sent to the SMSF function for forwarding the message to the C-party.

The SMSF function will interface the Unicom message gateway between the GSM and the CDMA networks which will be responsible for generating the billing and CDR of the message “A to C”. To avoid double billing of the A-party, the SMSF function will also send the information of the B-party to the Unicom message gateway. The Unicom message gateway generates the CDR to record the forwarding party B after processing the B-party information.

The Unicom billing system recognizes the presence of the forwarding party from the Unicom message gateway CDR and bills the B-party (the forwarding party) instead of the A-party.

The SMSF function generates the CDR of the forwarding delivery. But the CDR of the SMSF function is sent to the Unicom billing system based on the recognition of the destination Unicom message gateway since the Unicom message gateway only has successful delivery status.

In accordance with an eighth embodiment of the billing system, the billing system of an operator, for example, China Unicom, uses CDMA and GSM networks. In this case, a China Unicom CDMA subscriber A sends a message to a China Unicom CDMA subscriber B who has set forwarding to a China Unicom GSM subscriber C.

A SMSC of the A-party generates the CDR and billing on the A-party for the message “A to B”. The SMSF function attempts the delivery of the message “A to C” through the Unicom message gateway between the CDMA and the GSM networks, which will be responsible to generate the billing and CDR of the message “A to C”. To avoid double billing to the A-party, the SMSF function also sends information on the B-party to the Unicom message gateway. The Unicom message gateway generates the CDR to record the forwarding party B after processing the B-party information.

The Unicom billing system recognizes the presence of the forwarding party from the Unicom message gateway CDR and bills the B-party (the forwarding party) instead of the A-party. The SMSF function generates the CDR of the forwarding delivery. But the CDR will not be sent to the Unicom billing system based on the recognition of the destination message gateway since the message gateway contains only successful delivery status.

In accordance with a ninth embodiment of the billing system, the billing system of different party operators, for example Unicom, uses CDMA and GSM networks. Here, either a GSM or a CDMA Unicom subscriber is sent to a GSM or a CDMA Unicom subscriber who has set message forwarding to a 3^{rd} party operator such as China Mobile, Xiao Ling Tong etc.

If the “A to B” message delivery does not involve a Unicom message gateway, the SMSC of the A-party generates the CDR and billing on the A-party for the message “A to B”. Otherwise, the Unicom message gateway generates the CDR and billing on the A-party for the message “A to B”. The “A to B” CDR of the A-party generated by the SMSC will not be considered for billing if two different networks between the sending number (A-party) and the receiving number (B-party) are recognized.

The SMSF function will be responsible for forwarding the “A to B” message. By attempting the delivery of “A to C” message through the Unicom message gateway between China Unicom and the 3^{rd} party operator networks, the Unicom message gateway will be responsible for generating the billing and CDR of “A to C” message. To avoid double billing the A-party, the SMSF function sends the B-party information to the Unicom message gateway as well. The Unicom message gateway generates the CDR to record the forwarding party B after processing the B-party information.

The Unicom billing system recognizes the presence of the forwarding party from the message gateway CDR and bills the B-party instead of the A-party for the message delivery.

The SMSF function also generates the CDR of the forwarding message. But the CDR will not be sent to the Unicom Billing System based on the recognition of the destination message gateway since the message gateway will contain only successful delivery status.

Other Variations

Provided above for the edification of those of ordinary skill in the art, and not as a limitation on the scope of the present invention are detailed illustrations of a scheme for scalable message forwarding in a wireless communication network. Numerous variations and modifications within the spirit of the present invention will of course occur to those of ordinary skill in the art in view of the embodiments that have now been disclosed. For example, while the present invention is implemented primarily from the point of view of GSM mobile networks in the described embodiments, the present invention may also be effectively implemented on, for example, but not limited to, CDMA, 3G, WCDMA, GPRS, etc., or any other network of common carrier telecommunications.

As detailed in the illustrative examples contained here, the examples under the present invention are described using terms and constructs drawn largely from GSM mobile telephony infrastructure. However, the examples should not be interpreted so as to limit the present invention to the media described in the illustrations. Scalable message forwarding—a method of forwarding messages sent to a subscriber address in a forwarding service, wherein the forwarding is done to at least one forward-to address associated with the subscriber address—can be provided through any type of telecommunications medium, including, without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

Technical References

GSM 902, GSM 340, SMPP 3.4, GSM 408, ANSI-41, GSM 311, GSM 322, GSM-318, GSM

APPENDIX

| Acronym | Description |
|---|---|
| CAMEL | Customized Application for Mobile Enhanced Logic |
| CDMA | Code Division Multiplexed Access |
| CFU | Call Forwarding Number |
| Fwd-SM | Forward Short Message |
| GMSC | Gateway MSC |
| GPRS | General Packet Radio System |
| GSM | Global System for Mobile |
| HLR | Home Location Register |
| HPMN | Home Public Mobile Network |
| IMSI | International Mobile Subscriber Identity |
| ISD | MAP Insert Subscriber Data |
| LUP | MAP Location Update |
| MAP | Mobile Application Part |
| MO | Mobile Originated |
| MSC | Mobile Switching Center |
| MSISDN | Mobile Subscriber ISDN Number |
| MSRN | Mobile Subscriber Roaming Number |
| MT | Mobile Terminated |
| PC | Point Code (also SPC—Signaling Point Code) |
| PSI | Public Subscriber Information |
| SGSN | Serving GPRS Support Node |
| SIM | Subscriber Identity Module |
| SMS | Short Message Service |
| SMSC | SMS Center |
| SMSF | SMS Forwarding Function |
| SRI-SM | Send Routing Information for Short Message |
| SS7 | Signaling System 7 |
| SSN | Sub System Number |
| STK | SIM Tool Kit |
| STP | Signal Transfer Point |
| TDMA | Time Division Multiplexed Access; |
| VLR | Visited Location Register |
| VMSC | Visited Mobile Switching Center |
| VPMN | Visited Public Mobile Network |
| WCDMA | Wideband CDMA Access |
| WIB | Wireless Internet Browser (on SIM) |
| WLL | Wireless Local Loop |

What is claimed is:

1. A method of forwarding messages sent to a subscriber address in a forwarding service, wherein the forwarding is done to at least one forward-to address associated with the subscriber address, the method comprising:
a. maintaining a record of subscriber addresses and associated forward-to addresses in a forwarding-associations database;
b. updating a location-information database to redirect messages to a forwarding service address, if the messages are addressed to the subscriber address; and
c. sending the redirected messages to at least one forward-to address associated with the subscriber address using the forwarding-associations database.

2. The method according to claim 1 further comprising updating the availability of the subscriber address to receive messages.

3. The method according to claim 2, wherein updating the availability comprises receiving a notification from the location-information database when the location-information database receives a location update from the subscriber address.

4. The method according to claim 3, further comprising suspending the redirected messages to be sent to at least one forward to address.

5. The method according to claim 5, further comprising updating a location-information database to redirect messages to the forwarding service address, if the message forwarding is continued.

6. The method according to claim 2, wherein updating the availability comprises polling the subscriber address for checking availability.

7. The method according to claim 6, wherein polling the subscriber address comprises interfacing a database of network monitoring over a network interface to check if any network measurement results has been sent by the subscriber address over the network interface.

8. The method according to claim 1, wherein the forwarding service is a Short Messaging Service Forwarding function (SMSF) in a telecommunications network.

9. The method according to claim 8, wherein the telecommunications network is selected from a group consisting of a GSM network, CDMA network, and 3G network.

10. The method according to claim 1, wherein the location-information database is a Home Location Register (HLR) of a telecommunications network.

11. The method according to claim 1, wherein the subscriber address is a mobile phone number.

12. The method according to claim 1, wherein the subscriber address is an International Mobile Subscriber Identity (IMSI).

13. The method according to claim 1, wherein each forward-to address is selected from a group consisting of a phone number (MSISDN), an International Mobile Subscriber Identity (IMSI), an email address, a Blackberry address, a uniform resource identifier (URI), a mobile identity number (MIN), an equipment identifier (e.g., IMEI, ESN etc), a SIP address, and a Rich Site Summary (RSS) feed generator address.

14. The method according to claim 1, wherein sending the redirected messages comprises:
a. extracting the subscriber address from the message;
b. looking up at least one forward-to address associated with the extracted subscriber address; and
c. forwarding the message to at least one looked up forward-to address.

15. The method according to claim 2 further comprising maintaining a forwarding-log to record all the redirected messages forwarded through the forwarding service address.

16. The method according to claim 15 further comprising sending a report of forwarded messages to the subscriber address using the forwarding-log once the subscriber address is available to receive messages.

17. The method according to claim 1, wherein sending the redirected messages comprises:
a. confirming whether the redirected messages were delivered to the at least one forward-to address;
b. sending an acknowledgement to the original sender of the redirected messages, if the redirected messages were delivered successfully; and
c. retrying delivery of the redirected messages, if the redirected messages were not delivered successfully.

18. The method according to claim 17, wherein retrying delivery comprises:
a. notifying the availability of at least one forward-to address to the forwarding service; and
b. notifying the location-information database of the availability of the subscriber address.

19. The method according to claim 18, further comprising:
a. notifying the original sender the availability of the subscriber address; and
b. restarting the message delivery process to the subscriber address.

20. The method according to claim 18, further comprising optionally storing the redirected messages by the forwarding service.

21. A system for providing a forwarding service for messages sent to a subscriber address, wherein the forwarding is done to at least one forward-to address associated with the subscriber address, the system comprising:
a. a forwarding-associations database maintaining a record of subscriber addresses and associated forward-to addresses;
b. a redirection logic updating a location-information database to redirect messages to a forwarding service address, if the messages are addressed to the subscriber address; and
c. a forwarding logic sending the redirected messages to at least one forward-to address associated with the subscriber address using the forwarding-associations database.

22. The system according to claim 21 further comprising a subscriber availability detection logic updating the availability of the subscriber address to receive messages.

23. The system according to claim 22, wherein the subscriber availability detection logic comprises means for receiving a notification from the location-information database when the location-information database receives a location update from the subscriber address.

24. The system according to claim 22, the subscriber availability detection logic comprises a polling logic checking availability of the subscriber address.

25. The system according to claim 24 wherein the polling logic comprises means for interfacing a database of network monitoring over a network interface to check if any network measurement results has been sent by the subscriber address over the network interface.

26. The system according to claim 25, wherein the network interface is selected from a group consisting of an Abis interface and an A-interface.

27. The system according to claim 21, wherein the forwarding service is a Short Messaging Service Forwarding function (SMSF) in a telecommunications network.

28. The system according to claim 27, wherein the telecommunications network is selected from a group consisting of a GSM network, CDMA network, and 3G network.

29. The system according to claim 21, wherein the location-information database is a Home Location Register (HLR) of a telecommunications network.

30. The system according to claim 21, wherein the subscriber address is a mobile phone number.

31. The system according to claim 21, wherein the subscriber address is an International Mobile Subscriber Identity (IMSI).

32. The system according to claim 21, wherein each forward-to address is selected from a group consisting of a phone number (MSISDN), an International Mobile Subscriber Identity (IMSI), a mobile identity number (MIN), an equipment identifier (IMEI, ESN etc), an email address, a Blackberry address, a uniform resource identifier (URI), a SIP address and a Rich Site Summary (RSS) feed generator address.

33. The system according to claim 21, wherein the forwarding logic comprises:
a. means for extracting the subscriber address from the message;
b. means for looking up at least one forward-to address associated with the extracted subscriber address; and
c. means for forwarding the message to at least one looked up forward-to address.

34. The system according to claim 33 further comprising a forwarding-log to record all the redirected messages forwarded through the forwarding service address.

35. The system according to claim 34 further comprising means for sending a report of forwarded messages to the subscriber address using the forwarding-log once the subscriber address is available to receive messages.

36. The system according to claim 21, further comprising a billing logic to generate a call detail report for the subscriber address and at least one forward-to address.

37. A method of forwarding messages and calls sent to a subscriber address in a forwarding service, wherein the forwarding is done to at least one forward-to address associated with the subscriber address, the method comprising:
a. maintaining a record of subscriber addresses and associated forward-to addresses in a forwarding-associations database;
b. updating a location-information database to redirect messages and calls to a forwarding service address, if the messages and calls are addressed to the subscriber address; and
c. sending the redirected messages and calls to at least one forward-to address associated with the subscriber address using the forwarding-associations database.

38. The method according to claim 37 wherein the messages and the calls are forwarded to same forward-to address.

39. The method according to claim 38 wherein the messages and the calls are forwarded to different forward-to address.

40. A method of forwarding messages sent to a subscriber address in a forwarding service, wherein the forwarding is done to a forward-to address associated with the subscriber address, the method comprising:
a. maintaining a record of subscriber addresses and associated forward-to addresses in a forwarding-associations database;
b. updating a location-information database to redirect messages to a forwarding service address, if the messages are addressed to the subscriber address; and
c. sending the redirected messages to the forward-to address associated with the subscriber address using the forwarding-associations database.

41. A method of forwarding messages sent to a subscriber address in a forwarding service, wherein the forwarding is done to at least one forward-to address associated with the subscriber address, the method comprising:
a. maintaining a record of subscriber addresses and associated forward-to addresses in a forwarding-associations database;
b. updating a location-information database to redirect messages to a forwarding service address, if the messages are addressed to the subscriber address;
c. sending the redirected messages to at least one forward-to address associated with the subscriber address using the forwarding-associations database;
d. updating the availability of the subscriber address to receive the messages; and
e. maintaining a forwarding-log to record all the redirected messages forwarded through the forwarding service address.

42. A method of forwarding messages sent to a forwarding address in a forwarding service using a GSM network, wherein the forwarding is done to at least one forward-to address associated with the subscriber address, the method comprising:
a. maintaining a record of subscriber addresses and associated forward-to addresses in a forwarding-associations database;
b. updating an HLR to redirect messages to a forwarding service address, if the messages are addressed to the forwarding address; and
c. sending the redirected messages to at least one forward-to address associated with the forwarding address using the forwarding-associations database.
